(19) United States
(12) Patent Application Publication
(10) Pub. No.: US 2026/0221019 A1
(43) Pub. Date: Jul. 30, 2026

(54) ALERTING DEVICE FOR WARNING OF ANOMALIES IN BEHAVIORAL PATTERNS

(71) Applicant: ANYWARE SOLUTIONS APS, Ringsted (DK)

(72) Inventor: Morten BREMILD, Zug (CH)

(73) Assignee: ANYWARE SOLUTIONS APS, Ringsted (DK)

(21) Appl. No.: 19/140,845

(22) PCT Filed: Dec. 20, 2023
(86) PCT No.: PCT/DK2023/050322

§ 371 Date: Jun. 18, 2025

(30) Foreign Application Priority Data
Dec. 20, 2022 (DK) PA202270634

(51) Int. Cl. G08B 21/04

(52) U.S. Cl. CPC G08B 21/0492; G08B 21/0423; G08B 21/0469

(57) ABSTRACT

The present invention relates to an alerting device for warning of anomalies in the behavioral patterns of a person. The device comprises one or more ambient sensoring means that includes one or more ambient sound sensoring means. The ambient sensoring means continuously monitor real-time data originating from behavioral patterns of a person and one or more pre-defined pattern profiles stored in the device, including one or more pre-defined sound patterns transformed via a Fast Fourier Transform (FFT) algorithm and one or more computing means. The computing means being configured to continuously transform real-time sound monitored by the one or more ambient sound sensoring means and continuously perform a pattern recognition, including a continuous comparison of the one or more real-time FFT Sound Pattern Profiles with the one or more predefined FFT Sound Pattern Profiles and execute an alert based on the one or more stored event triggers.

### FIELD OF THE INVENTION

The present invention relates to the field of devises that can monitor behavioral patterns of a person without compromising privacy. More particularly, the present invention relies on ambient sensoring means for continuously monitoring anomalies by pattern recognition.

### BACKGROUND OF THE INVENTION

In recent years, more attention has been given to elderly care given the demographic development and solutions for providing elderly persons the best possible care while at the same time maintaining privacy. Also, an increasing group of elderly persons choose to live in private homes due to improved health care and possibilities to do activities of daily living without compromising quality of life.

Although an increase in care personnel may be a solution with respect to elderly care, it may not always be a preferred solution due to increased demands to privacy and lack of qualified personnel. At the same time, elderly persons may need to feel comfort in emergency attendance if something goes wrong, such as illness or accidents in their homes, without intruding supervision and privacy intrusion. Also, other sectors, such as the disability sector would benefit of less intrusive solutions.

Hitherto, the solutions available for increased attention to behavoiral patterns of persons, apart from labour demanding supervision, involve solutions that are intrusive with respect to privacy. For instance, continuous surveillance of elderly people by microphones or cameras that may recognize spoken words provides discomfort in the Activities of Daily Living (ADL). This may result in decreased quality of life and decreased activity when it comes to certain activities, such as speech or daily living.

Accordingly, there is a need for solutions that circumvent the above-mentioned disadvantages and solutions that improve privacy commitment.

### SUMMARY OF THE INVENTION

The present invention pertains to an alerting device for warning of anomalies in the behavioral patterns of a person. The device comprises one or more ambient sensoring means comprising one or more ambient sound sensoring means, the one or more ambient sensoring means being adapted to continuously monitor real-time data originating from behavioral patterns of a person. Further the device comprises one or more pre-defined pattern profiles stored in the device, including one or more pre-defined sound patterns transformed via a Fast Fourier Transform (FFT) algorithm into one or more pre-defined FFT Sound Pattern Profiles.

Additionally, the device comprises one or more computing means configured to: continuously transform real-time sound monitored by the one or more ambient sound sensoring means via a Fast Fourier Transform (FFT) algorithm into one or more real-time FFT Sound Pattern Profiles, thereby allowing a privacy-protecting detection of the ambient sound from the site of operation;
continuously perform a pattern recognition, including a continuous comparison of the one or more real-time FFT Sound Pattern Profiles with the one or more pre-defined FFT Sound Pattern Profiles;
store one or more event triggers on the device in case of a match between real-time data and the one or more pre-defined pattern profiles, including a match between the one or more real-time FFT Sound Pattern Profiles and the one or more pre-defined FFT Sound Pattern Profiles; and
execute an alert based on the one or more stored event triggers if pre-set data sharing permissions allow it, thereby warning of anomalies in the behavioral patterns of a person.

One of the advantages of the present invention is that monitoring of behavioral patterns of a persons may be performed with a high degree of privacy. The use of a Fast Fourier Transform (FFT) algorithm may allow transforming ambient sound from the site of operation into real-time FFT Sound Patterns Profiles. In that way, the device may be applied for specific purposes and specific activities, defined prior to setting up the system. Additionally, by using FFT, the system cannot detect spoken words in the surrounding location where the system is set up. Compared to applying only ambient sensoring means, the system may be more secure with respect to privacy.

By applying real-time FFT Sound Pattern Profiles and comparing these with the one or more pre-defined FFT Sound Pattern Profiles, the system is operable to detect variations and deviations compared to pre-defined conditions. This may again allow a more realiable and a more response-active system for detection of anomalies. For instance, compared to relying on monitoring ambient parameters, such as ambient sound, the device may be more precise with respect to certain characteristic sound patterns, such as showering patterns, toileting patterns, running water patterns, vacuuming patterns, presence patterns, absence patterns, and combinations thereof.

While the device may be set up to only monitor sound patterns, in some embodiments it may be advantageous to also include other patterns, such as humidity patterns, CO2 patterns, etc. These patterns may be correlated with the one or more pre-defined FFT Sound Pattern Profiles, or the one or more pre-defined FFT Sound Pattern Profiles may be correlated with these patterns. It may also be possible to combine the device with ambient monitoring of ambient data, such as humidity, CO2, etc. In this way, the one or more real-time FFT Sound Pattern Profiles may advantageously be combined with monitoring of ambient conditions on site of operation. This may allow for a more precise detection of behavioral patterns of a person since these additional parameters may both contribute to double-check the one or more real-time FFT Sound Pattern Profiles and add more data to contribute to precision.

One of the advantages of the present invention is also that the one or more pre-defined FFT Sound Pattern Profiles may very precisely reflect the pattern profiles on the site of operation. Hence, by comparing the one or more real-time FFT Sound Pattern Profiles with the one or more pre-defined FFT Sound Pattern Profiles, it may be possible to obtain a very realistic recognition of patterns on the site of operation. Additionally, the device may be placed either very close to the site of operation of a person, which may allow a very realistic and prompt response on behavioral patterns, or the device may also be placed in a longer distance from the site of operation. Since it is the patterns that are recognized by the system, it may under these circumstances be less important with the strength of a signal. Just if the pattern is present, the device may be able to execute alerts if one or more event triggers on the device allows it.

In the present context, an alert may constitute a notification on a mobile device, a remote message for external personnel, a high sound, visual LED feedback on the device, or the like. It may be based on one or more pre-defined pattern profiles that match with the pre-defined patterns profiles, including the one or more pre-defined FFT Sound Pattern Profiles. However, it may also be supported by a match between ambient humidity and pre-defined humidity, and other parameters to obtain a more complicated system with various parameters to be detected on the site of operation.

In this respect, it is noted that the one or more pre-defined pattern profiles for one or more categories of parameters may comprise multiple pre-defined pattern profiles, For instance, pre-defined sound patterns may be stored in the device for various sound patterns, such as toilet flushing, vacuuming, etc. The same applies to humidity, CO2, VOC, and other parameters, depending on the characteristics of the site of operation for the device and the desired events to be detected.

In some embodiments of the invention, the one or more ambient sensoring means comprises one or more ambient humidity sensoring means being adapted to continuously monitor real-time humidity.

In some embodiments of the invention, the one or more ambient sensoring means comprises one or more ambient temperature sensoring means being adapted to continuously monitor real-time temperature.

In some embodiments of the invention, the one or more ambient sensoring means comprises one or more ambient CO2 sensoring means being adapted to continuously monitor real-time CO2.

In some embodiments of the invention, the one or more ambient sensoring means comprises one or more ambient VOC sensoring means being adapted to continuously monitor real-time VOC.

In some embodiments of the invention, the one or more ambient sensoring means comprises one or more ambient light sensoring means being adapted to continuously monitor real-time light.

In some embodiments of the invention, the one or more ambient sensoring means comprises one or more ambient water flow sensoring means being adapted to continuously monitor real-time water flow.

In the present context “ambient” refers to conditions outside the device. In some cases, the data from the sensoring means is to be converted to reflect outside “ambient” conditions, such as temperature or humidity data. In that case, an algorithm may be applied. In other cases, the data may not need further conversions. In some embodiments, external ambient sensoring means are connected to the device. In some cases, the ambient sensoring means are located inside the device. In some cases, the ambient sensoring means are located on the surface of the device.

In some embodiments of the invention, the one or more pre-defined pattern profiles includes one or more pre-defined pattern profiles selected from the group consisting of humidity pattern profiles, temperature pattern profiles, CO2 pattern profiles, VOC pattern profiles, light pattern profiles, water flow pattern profiles, and combinations thereof.

In one embodiment of the invention, the one or more pre-defined pattern profiles includes one or more pre-defined humidity pattern profiles. In one embodiment of the invention, the one or more pre-defined pattern profiles includes one or more pre-defined temperature pattern profiles. In one embodiment of the invention, the one or more pre-defined pattern profiles includes one or more pre-defined CO2 pattern profiles. In one embodiment of the invention, the one or more pre-defined pattern profiles includes one or more pre-defined VOC pattern profiles. In one embodiment of the invention, the one or more pre-defined pattern profiles includes one or more pre-defined light pattern profiles. In one embodiment of the invention, the one or more pre-defined pattern profiles includes one or more pre-defined water flow pattern profiles.

In some embodiments of the invention, the pattern recognition includes a continuous comparison of real-time data monitored by the one or more ambient sensoring means, including ambient humidity sensoring means, with the one or more pre-defined pattern profiles.

In some embodiments of the invention, the one or more pre-defined pattern profiles comprises one or more pre-defined sensor pattern profiles.

In some embodiments of the invention, the one or more pre-defined sensor pattern profiles is correlated with the pre-defined FFT Sound Pattern Profiles. The intention with this embodiment is that other pattern profiles than the sound pattern profile may be applied to allow for a more precise and reliable recognition of anomalities. For instance, certain sound pattern profiles such as showering (running water in the shower) may have the system fail and trigger alerts, such as in cases where the pattern to be recognizes is less detailed (running water). If more than the sound pattern profiles are applied and correlated to the sound pattern profile, such as humidity pattern profiles, the system may be more precise and reliable.

In some embodiments of the invention, the one or more computing means is configured to store one or more event triggers on the device in case of a match between real-time data and at least two pre-defined pattern profiles, such as at least three pre-defined pattern profiles.

In some embodiments of the invention, the one or more event triggers includes a match between real-time data, including humidity data, and the one or more pre-defined pattern profiles.

In some embodiments of the invention, the alert is executed in case of a match of at least two event triggers. For instance, with respect to a match between the one or more real-time FFT Sound Pattern Profiles and the one or more pre-defined FFT Sound Pattern Profiles, two event triggers may be defined by a certain frequency band in one time frame and another frequency band in another time frame. It may also be a specific frequency band combined with a specific amplitude or a combination of both. Other event triggers may be possible dependent on the accuracy to be applied and the specific real-time FFT Sound Pattern Profiles.

Additionally, event triggers based on a match between real-time data and the one or more pre-defined pattern profiles amy also include other bars, such as a certain humidity bar when humidity is applied in the solution, a certain temperature bar or temperature development, VOC level, CO2 level, or the like. It is advantageous to combined FFT sound measurement with other real-time data, such as humidity. Especially, if the site of operation is bathroom, this parameter may be especially preferred. Here, it may reflect very precisely the behavoiral patterns of a person.

In some embodiments of the invention, the alert is executed in case of a match of at least three event triggers. In some embodiments of the invention, the alert is executed in case of a match of at least four event triggers. In some embodiments of the invention, the alert is executed in case of a match of at least five event triggers. In some embodiments of the invention, the alert is executed in case of a match of at least six event triggers. The present invention allows for a high number of event triggers to be combined to obtain a more accurate picture of the behavoiral patterns of a person.

In some embodiments of the invention, the behavioral pattern of a person includes Activities of Daily Living (ADL). A person skilled in the art would understand the meaning of Activities of Daily Living (ADL). In some cases, this expression is applied and used to characterize the daily activities in a household. The expression is also applied within elderly care or care of persons with anormal abilities. It may also be applied to other categories. While the present invention may cover more than Activities of Daily Living (ADL), in some embodiments ADL is especially suitable for the device of the present invention.

In some embodiments of the invention, the one or more pre-defined pattern profiles stored in the device comprises one or more pre-defined sound patterns and one or more pre-defined humidity patterns. Especially, humidity is advantageous in combination with sound, such as sound converted to FFT. In some embodiments, sound patterns may also comprise sound patterns that are not converted to FFT, albeit sound converted to FFT is also to be present. For instance, some sound patterns may more easily be detected without converting to FFT, which in combination with other sound patterns converter to FFT and optionally pattern profiles such as humidity pattern profiles, may contribute to an even more precise system.

In some embodiments of the invention, the one or more pre-defined pattern profiles is based on data selected from the group consisting of data originating from showering data, toileting data, running water, vacuuming data, presence data, absence data, and combinations thereof. In some embodiments of the invention, the one or more pre-defined pattern profiles is based on showering data. In some embodiments of the invention, the one or more pre-defined pattern profiles is based on toileting data. In some embodiments of the invention, the one or more pre-defined pattern profiles is based on running water data. In some embodiments of the invention, the one or more pre-defined pattern profiles is based on vacuuming data. For instance, increased use of a toilet may be a sign of illness or otherwise a sign of increased attention to the person. The same applies to the other data measurements.

In some embodiments of the invention, the one or more pre-defined pattern profiles is based on presence data. In some embodiments of the invention, the one or more pre-defined pattern profiles is based on absence data. It may be advantageous to combine with presence and/or absence data. In this respect, these expressions refer to presence and/or absence of a person, such as in a room, bathroom, etc. It for instance, presence is especially increased, it may be a sign of a deviation in the behavoiral pattern. The same applies with absence of a person. In some cases, absence data may be a sign of illness. In other cases, increased presence may also be a sign of illness or other situations. By combining these data to the other data, a clearer picture of a persons behavoiral pattern may be obtained.

In some embodiments of the invention, the one or more pre-defined pattern profiles stored in the device is adaptive by means of a learning algorithm. This learning algorithm may be based on Artificial Intelligence (AI), or Machine Learning (MC), or other learning algorithms. In this respect, it is noted that since the sound is converted to FFT, privacy is upheld and is of no concern. Hence, the present invention may apply AI without privacy intrusion, which is a particular advantage of the present invention. Accordingly, the present invention allows for a pre-defined setting that may be improved over time based on a learning algorithm.

In some embodiments of the invention, the Fast Fourier Transform (FFT) algorithm is performed in the device. By performing the transformation on the device as such, there would be less need for wireless connections and the transformation is intended to be performed at a faster speed and locally. In other embodiments, the FFT algorithm is performed in a cloud solution, for instance via a mobile device. This may be preferred in some embodiments, for instance if more data is to be integrated.

In some embodiments of the invention, the Fast Fourier Transform (FFT) algorithm is based on frequency bands.

In some embodiments of the invention, the pre-defined FFT Sound Pattern Profiles and the real-time FFT Sound Pattern Profiles are based on at least two frequency bands.

In some embodiments of the invention, the pre-defined FFT Sound Pattern Profiles and the real-time FFT Sound Pattern Profiles are based on at least three frequency bands.

In some embodiments of the invention, the pre-defined FFT Sound Pattern Profiles and the real-time FFT Sound Pattern Profiles are based on frequency bands in succession of each other.

In some embodiments of the invention, the pre-defined FFT Sound Pattern Profiles and the real-time FFT Sound Pattern Profiles are based on at least one low frequency band and one high frequency band.

In some embodiments of the invention, the pre-defined FFT Sound Pattern Profiles and the real-time FFT Sound Pattern Profiles are based on time slots of milliseconds, such as time slots of below 20 milliseconds. In some embodiments of the invention, the pre-defined FFT Sound Pattern Profiles and the real-time FFT Sound Pattern Profiles are based on time slots of milliseconds, such as time slots of below 10 milliseconds. In some embodiments of the invention, the pre-defined FFT Sound Pattern Profiles and the real-time FFT Sound Pattern Profiles are based on time slots of milliseconds, such as time slots of below 5 milliseconds.

In some embodiments of the invention, the pre-defined FFT Sound Pattern Profiles and the real-time FFT Sound Pattern Profiles are based on time slots of different time slots of frequency bands, such as time slots of below 20 milliseconds combined with time slots below 10 milliseconds. In some embodiments of the invention, the pre-defined FFT Sound Pattern Profiles and the real-time FFT Sound Pattern Profiles are based on time slots of different time slots, such as time slots of below 20 milliseconds combined with time slots below 5 milliseconds. In some embodiments of the invention, the pre-defined FFT Sound Pattern Profiles and the real-time FFT Sound Pattern Profiles are based on time slots of different time slots, such as time slots of below 10 milliseconds combined with time slots below 5 milliseconds.

In some embodiments of the invention, the pre-defined FFT Sound Pattern Profiles and the real-time FFT Sound Pattern Profiles includes amplitude thresholds in the frequency bands. In some embodiments of the invention, the pre-defined FFT Sound Pattern Profiles and the real-time FFT Sound Pattern Profiles includes different amplitude thresholds in the frequency bands. In some embodiments of the invention, the pre-defined FFT Sound Pattern Profiles and the real-time FFT Sound Pattern Profiles includes amplitude thresholds in the frequency bands combined with one or more time slots of frequency bands.

In some embodiments of the invention, the pre-defined FFT Sound Pattern Profiles and the real-time FFT Sound Pattern Profiles excludes background noise.

In some embodiments of the invention, the pre-defined FFT Sound Pattern Profiles are uploaded from a mobile device.

In some embodiments of the invention, the device does not store real-time data, thereby allowing a privacy-protecting detection of the ambient sound from the site of operation.

In some embodiments of the invention, the device does not recognize speech, thereby allowing a privacy-protecting detection of the ambient sound from the site of operation.

In some embodiments of the invention, the device is operable to perform machine learning and/or artificial intelligence and/or deep learning.

In some embodiments of the invention, the one or more pre-defined pattern profiles stored in the device comprises a dataset that is trained by a learning algorithm to correspond to a pattern profile from the site of operation.

In some embodiments of the invention, the one or more pre-defined pattern profiles comprises a dataset that is trained by a learning algorithm to correspond to a profile from the site of operation and trained by a learning algorithm to eliminate background noise from the site of operation.

In some embodiments of the invention, the one or more pre-defined sound patterns is recorded from the site of operation. In this embodiment, the pre-defined sound patterns may reflect an actual in situ sound pattern. For instance, a flushing toilet may be recorded form the site of operation, which allows a very precise detection of FFT sound. In other embodiments, more general sound patterns reflecting the specific event may be uploaded on the device, such as vacuuming. In order to further improve the system, a learning algorithm may be applied subsequently. This may allow data to approach real-time data.

In some embodiments of the invention, the one or more ambient sensoring means is present in the alerting device.

In some embodiments of the invention, all processing of data is performed in the alerting device.

The foregoing and other features and advantages of the invention will be apparent from the following more particular description of preferred embodiments of the invention, as illustrated in the accompanying drawings.

Further features and advantages of the present invention, as well as the structure and operation of various embodiments of the present invention, are described in detail below with respect to the accompanying drawings.

In the drawings, the same reference numbers indicate identical or functionally similar elements.

### BRIEF DESCRIPTION OF DRAWINGS

FIG. 1 illustrates a general solution provided by the device of the present invention and various sensoring means involved in the solution, including a microphone with FFT transformation. Further, the figure illustrates a solution provided by the device of the present invention and various sensoring means involved in the solution, including a showering pattern profile with a showering trigger, here correlated with humidity in Classifier 2.

### DETAILED DESCRIPTION

Accordingly, there has been provided an alerting device for warning of anomalies in the behavioral patterns of a person. The device comprises one or more ambient sensoring means comprising one or more ambient sound sensoring means, the one or more ambient sensoring means being adapted to continuously monitor real-time data originating from behavioral patterns of a person. Further the device comprises one or more pre-defined pattern profiles stored in the device, including one or more pre-defined sound patterns transformed via a Fast Fourier Transform (FFT) algorithm into one or more pre-defined FFT Sound Pattern Profiles.

The device comprises one or more computing means configured to: continuously transform real-time sound monitored by the one or more ambient sound sensoring means via a Fast Fourier Transform (FFT) algorithm into one or more real-time FFT Sound Pattern Profiles, thereby allowing a privacy-protecting detection of the ambient sound from the site of operation; continuously perform a pattern recognition, including a continuous comparison of the one or more real-time FFT Sound Pattern Profiles with the one or more pre-defined FFT Sound Pattern Profiles; store one or more event triggers on the device in case of a match between real-time data and the one or more pre-defined pattern profiles, including a match between the one or more real-time FFT Sound Pattern Profiles and the one or more pre-defined FFT Sound Pattern Profiles; and execute an alert based on the one or more stored event triggers if pre-set data sharing permissions allow it, thereby warning of anomalies in the behavioral patterns of a person.

In the following section reference will now be made in detail to the embodiments of the invention with reference to the figures. While the invention will be described in conjunction with the preferred embodiments, it will be understood that they are not intended to limit the invention to these embodiments. To the contrary, the invention is intended to cover alternatives, modifications, and equivalents, which may be included within the spirit and scope of the invention as defined by the appended claims. Furthermore, in the following detailed description of the present invention, numerous specific details are set forth to provide a thorough understanding of the present invention. As will be understood by one of ordinary skill in the art, the present invention may be practiced without these specific details. In other instances, well-known methods, procedures, components, and circuits have not been described in detail as to not unnecessarily obscure aspects of the present invention.

Hence, the embodiments of the figures are not limiting to the invention as a whole but are exemplified in order to provide at least one way to carry out the invention. Embodiments in the following section may be combined with other embodiments in the application as a whole and subsequently still be within the scope of the present invention.

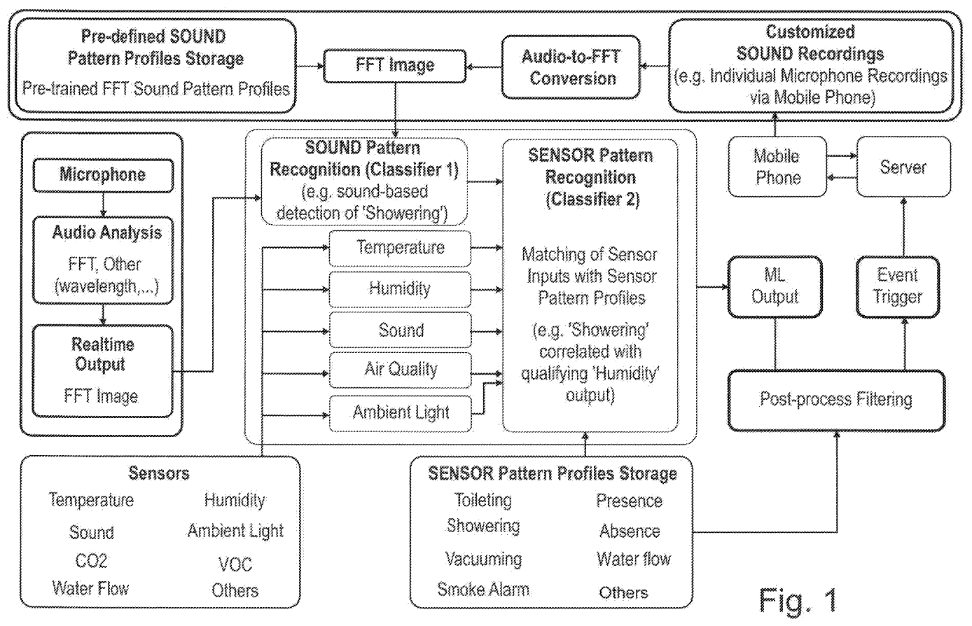

Turning now to FIG. 1 there is shown a Sensor Pattern Profiles storage and various sensoring means to detect various parameters. Here, a microphone is set up to detect ambient sound which is transformed via FFT to Real-time Sound Pattern Profiles, which are compared with Pre-defined Sound Pattern Profiles (Classifier 1). Also, sound files recorded from a smartphone can be turned into Pre-defined Sound Pattern Profiles for pattern recognition. To improve the overall pattern recognition, one or more various sensoring means are available that monitors humidity, temperature, noise (via the microphone), ambient light, CO2, VOC and other air quality parameters, a water flow sensoring means is available that monitors water flow. The real-time output of these sensoring means is continuously compared to Pre-defined Sensor Pattern Profiles, which are compared with the output of the Sound Pattern Profile recognition in Classifier 1 in a subsequent sensor correlation (Classifier 2). If there is a desired match, an event trigger is effectuated via an active trigger buffer. As illustrated here, Sound Patterns Recognition (Classifier 1) may be correlated with Sensor Pattern Recognition originating from sensors different from the microphone (Classifier 2). The result is an alert based on the one or more stored event triggers if pre-set data sharing permissions allow it, thereby warning of anomalies in the behavioral patterns of a person. The system is shown to be integrated with a server that interacts with the Sensor Pattern Profiles storage and a smartphone. The active trigger buffer may be applied to integrate various event triggers of the device.

With the present invention, several advantages may be achieved, including monitoring of behavioral patterns of a persons may be performed with a high degree of privacy. The use of a Fast Fourier Transform (FFT) algorithm may allow transforming ambient sound from the site of operation into real-time FFT Sound Patterns Profiles. In that way, the device may be applied for specific purposes and specific activities, defined prior to setting up the system. Additionally, the system may be set up to avoid detecting conversations and speech in the surrounding location where the system is set up. Compared to applying only ambient sensoring means, the system may be more secure with respect to privacy.

Also, one of the advantages of the present invention is also that the one or more pre-defined FFT Sound Pattern Profiles may very precisely reflect the patterns profiles on the site of operation. Hence, by comparing the one or more real-time FFT Sound Pattern Profiles with the one or more pre-defined FFT Sound Pattern Profiles, it may be possible to obtain a very realistic recognition of patterns on the site of operation.

Additionally, the device may be placed either very close to the site of operation of a person, which may allow a very realistic and prompt response on behavoiral patterns. The device may also be places in a longer distance from the site of operation and since it is the patterns that is recognized by the system, it may under these circumstances be less important with the strength of a signal. Just if the pattern is present, the device may be able to execute alerts if one or more event triggers on the device allows it.

Generally, a person skilled in the art would recognize the characteristics of Fast Fourtier Transform (FFT) algorithms as well as specific transformations by use of the algorithm. Particularly, a person skilled in the art would recognize identification of frequency bands and amplitudes by use of the algorithm.

One skilled in the art will appreciate that many variations are possible within the scope of the present invention. Thus, while the invention has been particularly shown and described with reference to the figures, it will be understood by those skilled in the art that these and other changes in form and details may be made therein without departing from the spirit and scope of the invention.

1. An alerting device for warning of anomalies in the behavioral patterns of a person, the device comprising:
one or more ambient sensoring means comprising one or more ambient sound sensoring means, the one or more ambient sensoring means being adapted to continuously monitor real-time data originating from behavioral patterns of a person;
one or more pre-defined pattern profiles stored in the device, including one or more pre-defined sound patterns transformed via a Fast Fourier Transform (FFT) algorithm into one or more pre-defined FFT Sound Pattern Profiles; and
one or more computing means configured to:
continuously transform real-time sound monitored by the one or more ambient sound sensoring means via a Fast Fourier Transform (FFT) algorithm into one or more real-time FFT Sound Pattern Profiles, thereby allowing a privacy-protecting detection of the ambient sound from the site of operation;
continuously perform a pattern recognition, including a continuous comparison of the one or more real-time FFT Sound Pattern Profiles with the one or more pre-defined FFT Sound Pattern Profiles;
store one or more event triggers on the device in case of a match between real-time data and the one or more pre-defined pattern profiles, including a match between the one or more real-time FFT Sound Pattern Profiles and the one or more pre-defined FFT Sound Pattern Profiles; and
execute an alert based on the one or more stored event triggers if pre-set data sharing permissions allow it, thereby warning of anomalies in the behavioral patterns of a person.

2. The alerting device according to claim 1, wherein the one or more ambient sensoring means comprises one or more ambient humidity sensoring means being adapted to continuously monitor real-time humidity.

3. The alerting device according to claim 1, wherein the one or more ambient sensoring means comprises one or more ambient temperature sensoring means being adapted to continuously monitor real-time temperature.

4. The alerting device according to claim 1, wherein the one or more ambient sensoring means comprises one or more ambient CO2 sensoring means being adapted to continuously monitor real-time CO2.

5. The alerting device according to claim 1, wherein the one or more ambient sensoring means comprises one or more ambient VOC sensoring means being adapted to continuously monitor real-time VOC.

6. The alerting device according to claim 1, wherein the one or more ambient sensoring means comprises one or more ambient light sensoring means being adapted to continuously monitor real-time light.

7. The alerting device according to claim 1, wherein the one or more ambient sensoring means comprises one or more ambient water flow sensoring means being adapted to continuously monitor real-time water flow.

8. The alerting device according to claim 1, wherein the one or more pre-defined pattern profiles includes one or more pre-defined pattern profiles selected from the group consisting of humidity pattern profiles, temperature pattern profiles, CO2 pattern profiles, VOC pattern profiles, light pattern profiles, water flow pattern profiles, and combinations thereof.

9. The alerting device according to claim 1, wherein the pattern recognition includes a continuous comparison of real-time data monitored by the one or more ambient sensoring means, including ambient humidity sensoring means, with the one or more pre-defined pattern profiles.

10. The alerting device according to claim 1, wherein the one or more pre-defined pattern profiles comprises one or more pre-defined sensor pattern profiles.

11. The alerting device according to claim 1, wherein the one or more pre-defined sensor pattern profiles is correlated with the pre-defined FFT Sound Pattern Profiles, or wherein the pre-defined FFT Sound Pattern Profiles are correlated with the one or more pre-defined sensor pattern profiles.

12. The alerting device according to claim 1, wherein the one or more computing means is configured to store one or more event triggers on the device in case of a match between real-time data and at least two pre-defined pattern profiles, such as at least three pre-defined pattern profiles.

13. The alerting device according to claim 1, wherein the one or more event triggers includes a match between real-time data, including humidity data, and the one or more pre-defined pattern profiles.

14. The alerting device according to claim 1, wherein the alert is executed in case of a match of at least two event triggers.

15. The alerting device according to claim 1, wherein the alert is executed in case of a match of at least three event triggers.

16. The alerting device according to claim 1, wherein the behavioral pattern of a person includes Activities of Daily Living (ADL).

17. The alerting device according to claim 1, wherein the one or more pre-defined pattern profiles stored in the device comprises one or more pre-defined sound patterns and one or more pre-defined humidity patterns.

18. The alerting device according to claim 1, wherein the one or more pre-defined pattern profiles is based on data selected from the group consisting of data originating from showering data, toileting data, running water, vacuuming data, presence data, absence data, and combinations thereof.

19. The alerting device according to claim 1, wherein the one or more pre-defined pattern profiles stored in the device is adaptive by means of a learning algorithm.

20. The alerting device according to claim 1, wherein the Fast Fourier Transform (FFT) algorithm is performed in the device.

21.-37. (canceled)
